(19) United States
(12) Patent Application Publication
(10) Pub. No.: US 2020/0161992 A1
(43) Pub. Date: May 21, 2020

(54) MOTOR DRIVE DEVICE

(71) Applicant: KONICA MINOLTA, INC., Tokyo (JP)

(72) Inventors: Takumi SHIRAKUMA, Tokyo (JP); Kenji IZUMIYA, Tokyo (JP)

(21) Appl. No.: 16/686,758

(22) Filed: Nov. 18, 2019

(30) Foreign Application Priority Data
Nov. 20, 2018 (JP) 2018-217344

(51) Int. Cl. H02P 5/50

(52) U.S. Cl. CPC H02P 5/50; H02P 2205/03

(57) ABSTRACT

A motor drive device controls driving of a plurality of motors that rotate a common drive shaft, and includes: a motor drive device that outputs the same drive power to each motor of the plurality of motors, and includes a motor drive controller that controls the drive power, using a rotation speed detection signal of a motor of the plurality of motors as a feedback signal; and a controller that determines a drive abnormality from the rotation speed detection signal of the motor or the drive power of the motor, wherein the controller determines a motor abnormal state and an overloaded state, from the drive power of the motor.

### CROSS REFERENCE TO RELATED APPLICATIONS

The present invention claims priority under 35 U.S.C. § 119 to Japanese Patent Application No. 2018-217344, filed on Nov. 20, 2018, is incorporated herein by reference in its entirety.

### BACKGROUND

### Technological Field

The present invention relates to a motor drive device including a plurality of motors.

### Description of the Related Art

There is a conventional technique for rotationally driving a common load (a drive shaft) with two motors. In the conventional technique, drive power is generated on the basis of a signal that is controlled for each of the two motors in accordance with information from a sensor (an encoder) that detects rotation of a load (an output shaft). Thus, the two motors are driven.

Meanwhile, in a case where a driving problem occurs in a motor drive device, it is necessary to grasp the cause of the problem.

For example, in JP 2017-163742 A, a check is made to determine whether a motor is in an overloaded state, from the PWM output value for the motor.

However, in a case where there is a problem with motor drive, it is necessary not only to check whether the motor is in a loaded state but also to determine whether the motor has no abnormality.

Meanwhile, in a double drive configuration using two motors, it is necessary to grasp which motor has a problem. However, it is not possible to determine a failure at only one motor for the two reasons described below. 1) In a case where determination is made on the basis of a FG signal (a rotation detection signal), if one of the motors is normal, the motors rotate at a predetermined rotation speed. Therefore, even if one of the motors breaks down and fails to produce an output or produces only a low output, an FG signal Is detected in the same manner as that at a time when both motors are normal.

By a conventional lock determination method, an error is detected when the rotation speed is outside the range of ±7.5% of a target rotation speed.

2) Since operation depends on the drive power of one of the motors, the drive power (the PWM operation amount) increases due to feedback control. However, torque can be expected to increase due to deterioration or a sudden abnormality on the load side, and therefore, such an increase in torque is not necessarily identified as a motor failure.

### SUMMARY

The present invention has been made in view of the above circumstances, and an object thereof is to provide a motor drive device capable of appropriately determining an abnormality in an individual motor or an overloaded state in a case where there is a problem with driving in the motor drive device that uses a plurality of motors.

To achieve the abovementioned object, according to an aspect of the present invention, there is provided a motor drive device that controls driving of a plurality of motors that rotate a common drive shaft, and the motor drive device reflecting one aspect of the present invention comprises: a motor drive device that outputs the same drive power to each motor of the plurality of motors, and includes a motor drive controller that controls the drive power, using a rotation speed detection signal of a motor of the plurality of motors as a feedback signal; and a controller that determines a drive abnormality from the rotation speed detection signal of the motor or the drive power of the motor, wherein the controller determines a motor abnormal state and an overloaded state, from the drive power of the motor.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a circuit block diagram of a motor drive circuit according to an embodiment of the present invention, and a schematic diagram of a rotary drive mechanism using two motors;

FIG. 2A is a waveform chart showing the initial fluctuations in the rotation speed of one motor when two motors are activated;

FIG. 2B is a waveform chart showing the fluctuations in the rotation speed of one motor when two motors are activated after degradation over time;

FIG. 3 is a flowchart of a control switching sequence according to a second example of switching control;

FIG. 4 is a waveform chart showing fluctuations in the rotation speed of one motor when two motors are activated in the second example of switching control;

FIG. 5 is a waveform chart showing fluctuations in the rotation speed of the other motor when two motors are activated in the second example of switching control;

FIG. 6 is a flowchart of a control switching sequence according to a third example of switching control;

FIG. 7 is a waveform chart showing fluctuations in the rotation speed and the drive power of one motor when two motors are activated in the third example of switching control;

FIG. 8 is a waveform chart showing fluctuations in the rotation speed and the drive power of the other motor when two motors are activated in the third example of switching control; and

FIG. 9 is a flowchart showing control procedures to be carried out in a case where a drive abnormality occurs in an embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

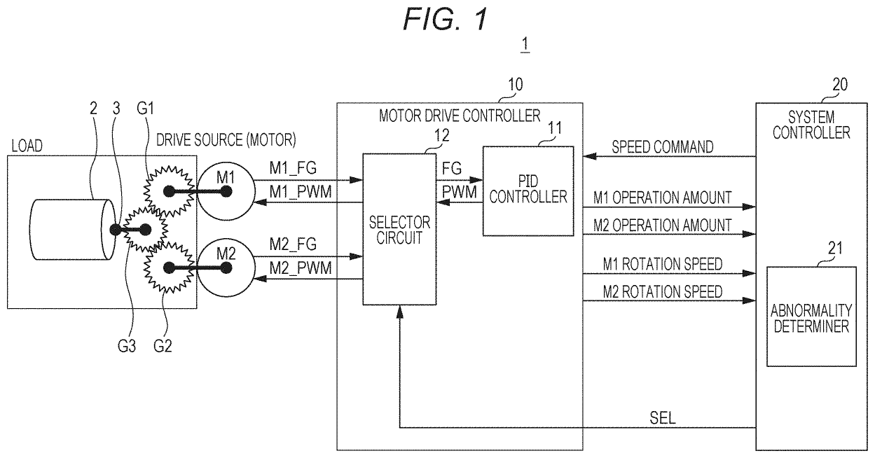

As shown in FIG. 1, a motor drive device 1 of this embodiment drives and controls two motors M1 and M2 that rotate a common drive shaft 3. For example, as shown in the drawing, the two motors M1 and M2 are connected to the drive shaft 3 by a transmission mechanism in which gears G1 and G2 secured to the output shafts of the respective motors mesh with a gear G3 secured to the drive shaft 3. However, this transmission mechanism is an example, and the present invention is not limited to this. For example, a reducing gear may be added.

The drive shaft 3 and a roller 2 are coaxially integrated. The roller 2, the drive shaft 3, and the gear G3 form a common load.

In this embodiment, a device having two motors has been described. However, the present invention is not limited to a device having two motors, and the device may include three or more motors.

The motor drive device 1 includes a motor drive controller 10 and a system controller 20.

The motor drive controller 10 includes a motor drive amplifier that outputs PWM drive power to the motors M1 and M2, and outputs the same drive power PWM to each of the two motors M1 and M2.

The motor drive controller 10 is also supplied with a rotation speed detection signal M1_FG output from the motor M1, and a rotation speed detection signal M2_FG output from the motor M2.

The motor drive controller 10 includes a PID controller 11. The rotation speed detection signal M1_FG or M2_FG of one of the two motors, whichever is selected by a selector 12, is input as a feedback signal to the PID controller 11, and the one of the two motors performs feedback control (PID control) to control drive power PWM. The motor drive controller 10 can switch the feedback signal between the rotation speed detection signals of the two motors M1 and M2 through operation of the selector 12 in accordance with a selection signal SEL output from the PID controller 11.

A speed command signal for specifying a target value for the feedback control (PID control), and the selection signal SEL are input from the system controller 20 to the PID controller 11.

An operation amount (a duty ratio) of the drive power (PWM) and the feedback signal (a rotation speed detection signal) in the feedback control (PID control) are input from the PID controller 11 to the system controller 20.

The system controller 20 outputs a speed command signal and a selection signal SEL to the PID controller 11, so that driving of the motors M1 and M2 is controlled. The system controller 20 also performs a computation process in accordance with information input from the PID controller 11 during the control of driving of the motors M1 and M2, to determine a selection signal SEL. Specific examples of the control are described below.

(1) First Example of Switching Control

In a first example of switching control, switching is performed when the cumulative number of starts or stops of the motors M1 and M2 exceeds a predetermined value.

The system controller 20 counts the number of starts of the motors M1 and M2, on the basis of a speed command signal or a feedback signal (a rotation speed detection signal).

The system controller 20 switches the selection signal SEL, when the cumulative number of starts of the motors M1 and M2 exceeds the predetermined value.

Specifically, when the cumulative number of starts of the motors M1 and M2 in a control operation in which the rotation speed detection signal M1_FG of the motor M1 is selected as the feedback signal exceeds the predetermined value, the system controller 20 switches the selection signal SEL to select the rotation speed detection signal M2_FG of the motor M2 as the feedback signal. In response to that, the PID controller 11 inputs the selection signal SEL to the selector 12, to switch the feedback signal to the rotation speed detection signal M2_FG of the motor M2.

Likewise, when the cumulative number of starts of the motors M1 and M2 in a control operation in which the rotation speed detection signal M2_FG of the motor M2 is selected as the feedback signal exceeds the predetermined value, the system controller 20 switches the selection signal SEL to select the rotation speed detection signal M1_FG of the motor M1 as the feedback signal. In response to that, the PID controller 11 inputs the selection signal SEL to the selector 12, to switch the feedback signal to the rotation speed detection signal M1_FG of the motor M1.

Switching may be performed on the basis of the cumulative number of stops, instead of the cumulative number of starts, or switching may be performed on the basis of the cumulative numbers of both.

As the feedback signal is switched every predetermined cumulative number of driving operations as described above, balance between the two motors M1 and M2 can be maintained, and smooth and efficient driving can be constantly performed.

(2) Second Example of Switching Control

In a second example of switching control, the feedback signal is switched to the one of the rotation speed detection signals of the two motors M1 and M2, with which responsiveness improves.

When the rotation speed at the start of the motors M1 and M2 fluctuates, a speed ripple occurs, or the rotation speed repeats overshooting and undershooting. The amplitude of the speed ripple gradually decreases, and the rotation speed converges to a target rotation speed rG.

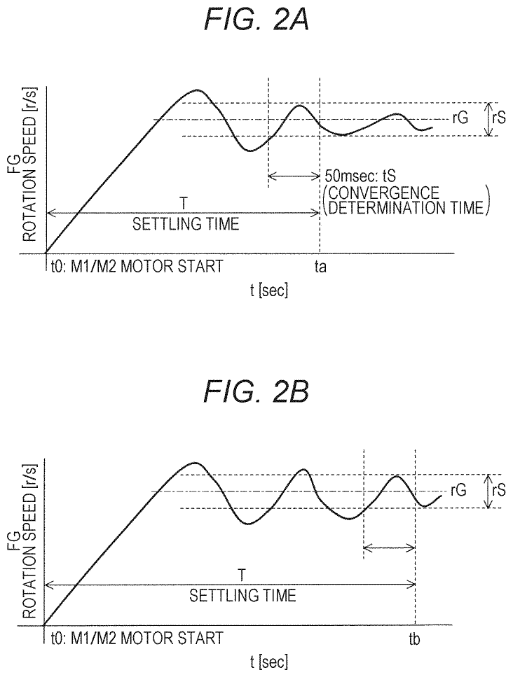

Since load conditions change due to aging such as gear wear, the maximum amplitude of the speed ripple becomes larger, and the settling time T until the speed ripple converges to a certain range becomes longer as shown in FIG. 2B. For example, the settling time T lasts until the point of time (a point of time to in FIG. 2A, or a point of time tb in FIG. 2B) when the rotation speed detection signal (FG) stays within a predetermined convergence range rS (±5%, for example) centered around the target rotation speed rG, for a predetermined convergence determination time tS (50 msec, for example). The starting point of the settling time T is an activation start time to.

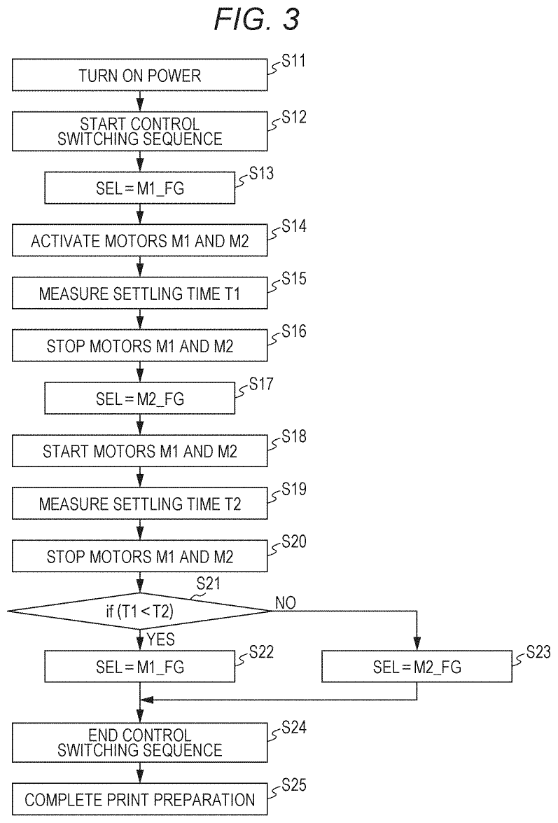

The system controller 20 executes the following control switching sequence for determining the selection signal SEL by checking whether responsiveness is good, on the basis of the length of the settling time T described above. The following is an example in which execution of a control switching sequence is started when power is turned on. However, a control switching sequence may be started at some other time such as a standby time. In the following example case, the motor drive device 1 is incorporated into a printer. Referring now to the flowchart shown in FIG. 3, this example case is described.

When the main power supply for the printer is turned on so that the power is turned on (S11), the system controller 20 starts a control switching sequence that is one of print preparation processes (S12). First in the control switching sequence, the system controller 20 inputs a selection signal SEL for selecting the rotation speed detection signal M1_FG of the motor M1 as the feedback signal to the PID controller 11, so that the rotation speed detection signal M1_FG of the motor M1 is selected as the feedback signal (S13).

After that, the system controller 20 inputs a speed command (a target rotation speed) to the PID controller 11, to simultaneously start rotation of the motors M1 and M2 (S14).

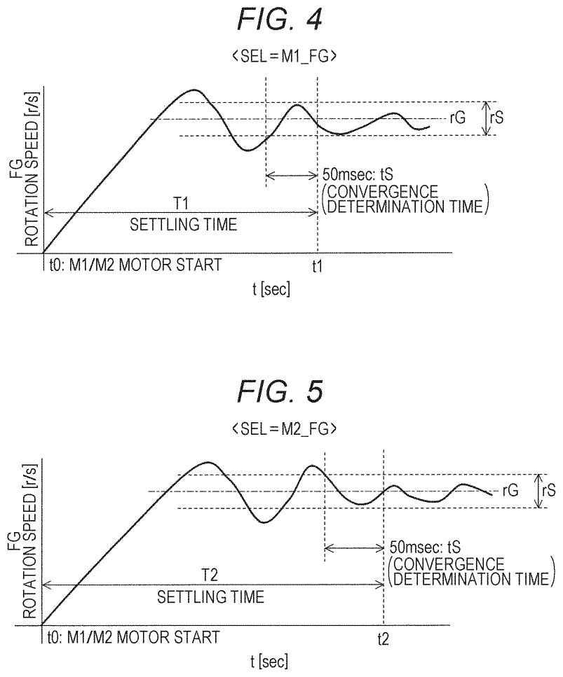

On the basis of a rotation speed detection signal (an FG signal) returned from the PID controller 11, the system controller 20 measures a settling time T1 as visualized in FIG. 4 (S15). This settling time T1 (corresponding to the zone t0-t1 in FIG. 4) is the settling time, when the rotation speed detection signal M1_FG of the motor M1 is the feedback signal.

After completing the measurement of the settling time T1, the system controller 20 inputs a speed command (a target rotation speed: 0) to the PID controller 11, to stop both the motors M1 and M2 (S16).

The system controller 20 then inputs a selection signal SEL for selecting the rotation speed detection signal M2_FG of the motor M2 as the feedback signal to the PID controller 11, so that the rotation speed detection signal M2_FG of the motor M2 is selected as the feedback signal (S17).

After that, the system controller 20 inputs a speed command (the same target rotation speed as that in S14) to the PID controller 11, to simultaneously start rotation of the motors M1 and M2 (S18).

On the basis of a rotation speed detection signal (an FG signal) returned from the PID controller 11, the system controller 20 measures a settling time T2 as visualized in FIG. 5 (S19). This settling time T2 (corresponding to the zone t0-t2 in FIG. 5) is the settling time, when the rotation speed detection signal M2_FG of the motor M2 is the feedback signal.

After completing the measurement of the settling time T2, the system controller 20 inputs a speed command (a target rotation speed: 0) to the PID controller 11, to stop both the motors M1 and M2 (S20).

If the settling time T2 is longer than the settling time T1 (YES in S21), the system controller 20 determines the selection signal to be a signal for selecting the rotation speed detection signal M1_FG of the motor M1 as the feedback signal (S22), and then ends the control switching sequence (S24). If the settling time T1 is longer than the settling time T2 (NO in S21), the system controller 20 determines the selection signal to be a signal for selecting the rotation speed detection signal M2_FG of the motor M2 as the feedback signal (S23), and then ends the control switching sequence (S24). In the example shown in FIG. 4 and FIG. 5, the selection signal is determined to be a signal for selecting the rotation speed detection signal M1_FG of the motor M1 as the feedback signal.

After performing all the print preparation processes, the system controller 20 enters a print preparation completed state (S25).

The system controller 20 inputs the selection signal determined in step S22 or S23 to the PID controller 11, and, until the next control switching sequence starts, performs control so that the rotation speed detection signal according to the selection signal is selected as the feedback signal. The PID controller 11 then controls driving of the motors M1 and M2 in conjunction with a print operation or the like.

As the feedback signal is switched to the rotation speed detection signal for improving responsiveness as described above, balance between the two motors M1 and M2 can be maintained, and smooth and efficient driving can be constantly performed.

In the above example, a check is made to determine whether responsiveness is good, on the basis of the length of the settling time T. However, determination may be made on the basis of some other criterion. For example, if overshooting and undershooting occur one time each after activation, the maximum amplitude can be measured, and thus, this may be used as a criterion. Further, if overshooting occurs once after activation, the amount of overflow with respect to the target rotation speed rG can be measured, and thus, this may be used as a criterion.

(3) Third Example of Switching Control

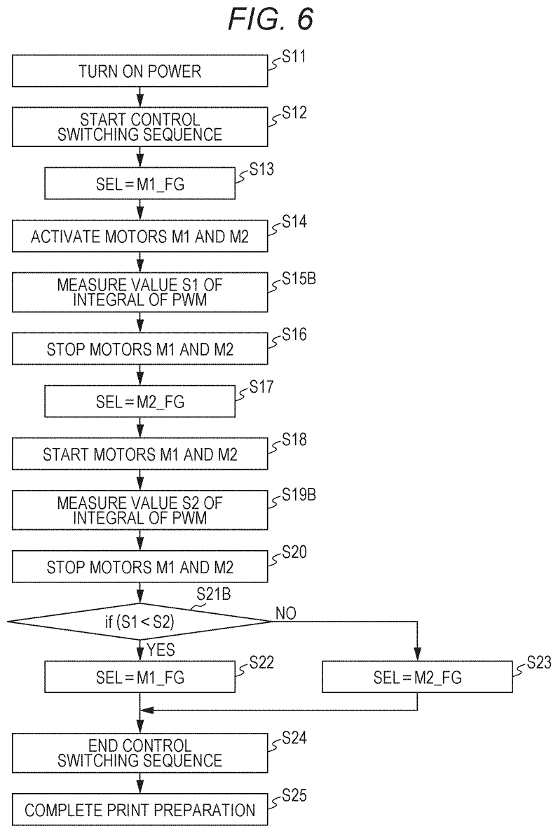

In a third example of switching control, the feedback signal is switched to the rotation speed detection signal of one of the two motors M1 and M2, which is the rotation speed detection signal that serves as the feedback signal to reduce the value of integral of the drive power before the rotation speed increases from a predetermined rotation speed (0 in this example) to the target rotation speed. Refer now to the flowchart shown in FIG. 6, this example is described. The same steps as those in the second example of switching control are denoted by the same reference numerals as those in the second example of switching control, and explanation of them is not repeated herein.

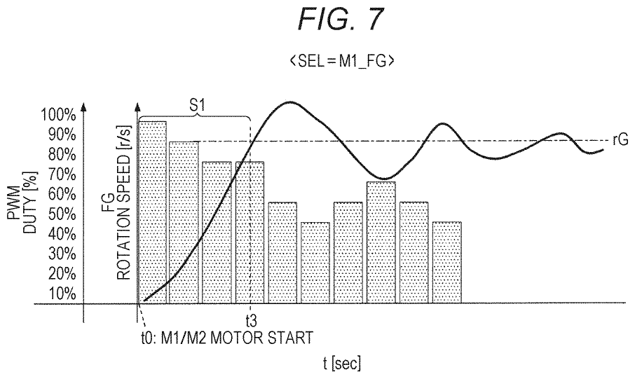

As shown in FIG. 6, after step S14, the system controller 20 measures the value S1 of integral of the drive power PWM as visualized in FIG. 7, on the basis of the operation amount (duty ratio) returned from the PID controller 11 (S15B). The value S1 of integral corresponds to the value of time integral of the duty ratio in the zone t0-t3 in FIG. 7, and is the value of integral when the rotation speed detection signal M1_FG of the motor M1 is the feedback signal.

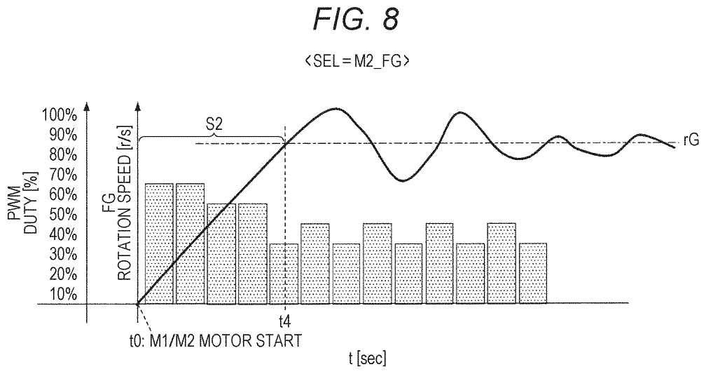

Likewise, after step S18, the system controller 20 measures the value S2 of integral of the drive power PWM as visualized in FIG. 8, on the basis of the operation amount (duty ratio) returned from the PID controller 11 (S19B). The value S2 of integral corresponds to the value of time integral of the duty ratio in the zone t0-t4 in FIG. 8, and is the value of integral when the rotation speed detection signal M2_FG of the motor M2 is the feedback signal.

If the value S2 of integral is greater than the value S1 of integral (YES in S21B), the system controller 20 determines the selection signal to be a signal for selecting the rotation speed detection signal M1_FG of the motor M1 as the feedback signal (S22), and then ends the control switching sequence (S24). If the value S1 of integral is greater than the value S2 of integral (NO in S21B), the system controller 20 determines the selection signal to be a signal for selecting the rotation speed detection signal M2_FG of the motor M2 as the feedback signal (S23), and then ends the control switching sequence (S24). In the example shown in FIG. 7 and FIG. 8, the selection signal is determined to be a signal for selecting the rotation speed detection signal M2_FG of the motor M2 as the feedback signal.

The other steps are carried out in the same manner as in the above described second example of switching control.

As the feedback signal is switched to the rotation speed detection signal for reducing the value of integral of the drive power as described above, balance between the two motors M1 and M2 can be maintained, and smooth and efficient driving can be constantly performed.

In the above embodiment, the number of the motors that rotate the common drive shaft is two. However, the number of motors may be three or more. In that case, the settling time or the value of integral of the drive power is measured each time the rotation speed detection signal of a motor is used as the feedback signal, and the shortest settling time or the smallest value of integral of the drive power should be selected. Further, every time a control switching sequence is executed, two of three or more motors may be selected at random, and the same procedures as those of the above embodiment may be carried out.

Next, measures to be taken when a drive abnormality occurs in the above drive device are described.

The premise and failure determination in a motor driving operation are defined as follows.

1) The drive configuration is such that the same PWM control is performed on both motors, on the basis of the rotation speed of one of the motors.

2) The motors are activated, and the PWM output amounts in a steady state are monitored.

3) In a case where a PWM output value is outside the normal range, the operation mode switches to a failure identifying mode.

4) FB control is performed on each individual motor so that its rotation speed becomes a predetermined rotation speed, and the PWM output value in a steady state is compared with a predetermined reference value (WRR_PWM).

[During Measurement of M1 Characteristics]

M1: FB control with signal M1_FG

M2: PWM output OFF (0%)

[During Measurement of M2 Characteristics]

M1: PWM output OFF

M2: FB control with signal M2_FG

Table 1 shows the relationship between the drive power during normal operation and the drive power during failure determination.

TABLE 1

| | M1 drive power | M2 drive power |
|---|---|---|
| During normal | M1_PWM = M2PWM | M2_PWM = M1PWM |
| operation | | |
| During failure | M1_PWM | OFF |
| determination | OFF | M2PWM |

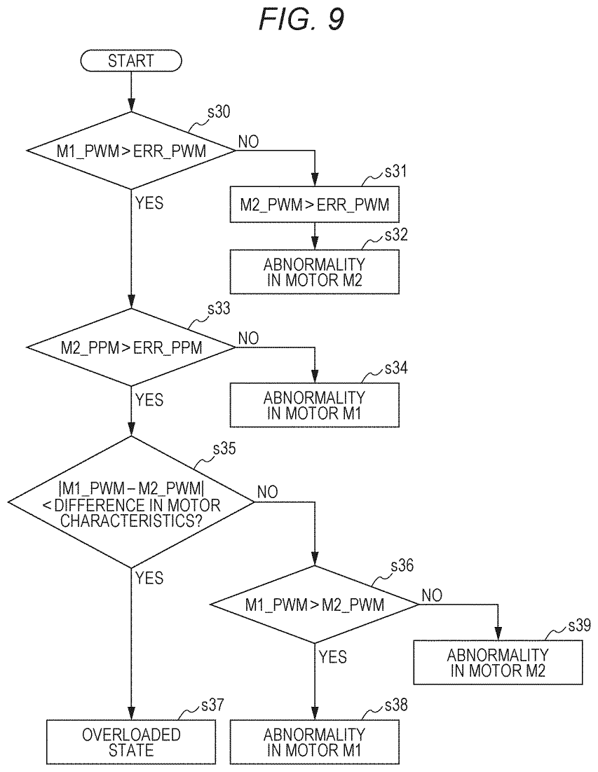

In the procedures for abnormality determination, a motor abnormality or a load abnormality is determined as shown in the flowchart in FIG. 9. The flowchart described below is executed under the control of the system controller 20. Therefore, in this embodiment, the system controller 20 corresponds to the controller. Further, the motor drive controller may be included in the controller.

When the failure identifying mode starts, an M1 characteristics measuring mode also starts, and a check is made to determine whether the PWM output value of the motor M1 is greater than the reference value (WRR_PWM) (step s30).

If the PWM output value of the motor M1 is not greater than the reference value (steps s30, N), an M2 characteristics measuring mode starts, and a check is made to determine whether the PWM output value of the motor M2 is greater than the reference value (WRR_PWM) (step s31). If the PWM output value of the motor M2 is greater than the reference value (WRR_PWM), only the motor M2 is determined to be abnormal (step s32).

If the PWM output value of the motor M1 is greater than the reference value (step s30, Y), a check is made to determine whether the PWM output value of the motor M2 is greater than the reference value (WRR_PWM) (step s33). If the PWM output value of the motor M2 is not greater than the reference value (WRR_PWM) (step s33, N), only the motor M1 is determined to be abnormal (step s34).

If the PWM output value of the motor M1 is greater than the reference value (step s33, Y), a check is made to determine whether the difference between the PWM output values of the motor M1 and the motor M2 is smaller than the value of a predetermined characteristics difference between the two motors (step s35).

If the difference between the PWM output values is smaller than the value of the predetermined characteristics difference between the two motors (step s35, Y), an overloaded state is detected (step s37).

If the difference between the PWM output values is not smaller than the value of the predetermined characteristics difference between the two motors (step s35, N), a check is made to determine whether the PWM value of the motor M1 in the M1 characteristics measuring mode is greater than the PWM value of the motor M2 in the M2 characteristics measuring mode (step s36).

If the PWM value of the motor M1 in the M1 characteristics measuring mode is greater than the PWM value of the motor M2 in the M2 characteristics measuring mode (step s36, Y), the motor M1 is determined to be abnormal (step 38).

If the PWM value of the motor M1 in the M1 characteristics measuring mode is not greater than the PWM value of the motor M2 in the M2 characteristics measuring mode (step s36, N), the motor M2 is determined to be abnormal (step s39).

Through the above procedures, it is possible to accurately determine which motor has an abnormality or is in an overloaded state in a case where a drive abnormality occurs in a motor drive device including a plurality of motors.

The motor drive device according to this embodiment can be used in sheet conveyance or a fixing device in an image forming apparatus. However, applications of the motor drive device are not limited to the above, and the motor drive device may of course be used in an apparatus other than an image forming apparatus.

Although embodiments of the present invention have been described and illustrated in detail, the disclosed embodiments are made for purposes of illustration and example only and not limitation, and appropriate modifications may be made to it without departing from the scope of the present invention. The scope of the present invention should be interpreted by terms of the appended claims.

What is claimed is:

1. A motor drive device that controls driving of a plurality of motors that rotate a common drive shaft,
the motor drive device comprising:
a motor drive device that
outputs the same drive power to each motor of the plurality of motors, and
includes a motor drive controller that controls the drive power, using a rotation speed detection signal of a motor of the plurality of motors as a feedback signal; and
a controller that determines a drive abnormality from the rotation speed detection signal of the motor or the drive power of the motor,
wherein the controller determines a motor abnormal state and an overloaded state, from the drive power of the motor.

2. The motor drive device according to claim 1, wherein the controller outputs drive power to only a motor of the plurality of motors, controls the drive power using a rotation speed detection signal as a feedback signal, and determines a motor abnormal state and an overloaded state from a magnitude of the controlled drive power.

3. The motor drive device according to claim 2, wherein the controller sets a threshold for the controlled drive power, and determines that a motor is in an abnormal state when the controlled drive power exceeds the threshold only in the motor.

4. The motor drive device according to claim 2, wherein the controller has a threshold for the controlled drive power, when the controlled drive power exceeds the threshold in a plurality of motors, and a difference in the controlled drive power between the motors is smaller than a value of a predetermined difference, the controller detects an overloaded state, and when the difference in the controlled drive power is not smaller than the value of the predetermined difference, the controller determines that the motor having the controlled drive power of the greater value is in an abnormal state.
